(19) United States
(12) Patent Application Publication
(10) Pub. No.: US 2025/0312227 A1
(43) Pub. Date: Oct. 9, 2025

(54) Walker Umbrella Device

(71) Applicant: Mary L. Zern, Orchard Park, NY (US)

(72) Inventor: Mary L. Zern, Orchard Park, NY (US)

(21) Appl. No.: 19/088,011

(22) Filed: Mar. 24, 2025

Related U.S. Application Data
(60) Provisional application No. 63/574,302, filed on Apr. 4, 2024.

(51) Int. Cl. A61H 3/04; A61H 3/00

(52) U.S. Cl. CPC A61H 3/04; A61H 2003/003

(57) ABSTRACT

A walker or rollator umbrella device is herein disclosed. More specifically, the device is an umbrella holder designed to be attached to a walker. The walker or rollator umbrella device comprises a body component and fasteners. Thus, once the device is fastened to a walker, a user can insert and open an umbrella in the body component and utilize the walker and an umbrella simultaneously.

### CROSS-REFERENCE TO RELATED APPLICATION

The present application claims priority to, and the benefit of, U.S. Provisional Application No. 63/574,302, which was filed on Apr. 4, 2024, and is incorporated herein by reference in its entirety.

### FIELD OF THE INVENTION

The present invention relates generally to the field of walker or rollator umbrella devices. More specifically, the present invention relates to an umbrella holder that attaches to a walker. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in walker or rollator umbrella devices. Generally, individuals who require a walker for mobility may be unable to travel outdoors during inclement weather. Holding onto and steering the walker is nearly impossible while trying to hold an umbrella.

As is known, if a walker user tries to go outside when it is raining, their clothes will inevitably get wet, and the walker wheels could slip on the wet ground. Individuals who do try to use a walker and an umbrella simultaneously may deal with difficulties, such as keeping the walker stable, maintaining the umbrella in an upright position, and more.

Accordingly, there is a demand for an improved walker or rollator umbrella device that attaches to a walker. More particularly, there is a demand for a walker or rollator umbrella device that enables walker or rollator users to use their walker and an umbrella simultaneously and safely.

Therefore, there exists a long felt need in the art for a walker or rollator umbrella device that provides users with a cylindrical holder for walkers designed to support an umbrella. There is also a long felt need in the art for a walker or rollator umbrella device that enables users to insert the umbrella handle into the holder and expand it, keeping it supported above the walker to keep the user dry and/or cool. Further, there is a long felt need in the art for a walker or rollator umbrella device that maintains independence for individuals who require a walker for mobility, enabling them to still go outdoors during sunny or rainy days. Finally, there is a long felt need in the art for a walker or rollator umbrella device that can be attached to any type and style of walker and maintain support over the user.

The subject matter disclosed and claimed herein, in one embodiment thereof, comprises a walker or rollator umbrella device. The device is a cylindrical holder for walkers designed to support an umbrella. The walker or rollator umbrella device enables users to insert the umbrella handle into the holder and expand it, keeping it supported above the walker. The walker or rollator umbrella device maintains independence for individuals who require a walker for mobility, enabling them to still go outdoors during sunny or rainy days. The umbrella walker device can be attached to any type and style of walker and maintain support over the user. Thus, once the device is attached to a walker, a user can place the handle of an umbrella into the device and stay dry and/or cool. Accordingly, the device preserves the independence of walker or rollator users.

In this manner, the walker or rollator umbrella device of the present invention accomplishes all of the forgoing objectives and provides users with a device that enables for the simultaneous use of a walker/rollator and an umbrella.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a walker or rollator umbrella device. The device is an umbrella holder designed to be attached to a walker. The walker or rollator umbrella device comprises a body component and fasteners. Thus, once the device is fastened to a walker, a user can insert and open an umbrella in the body component and utilize the walker and an umbrella simultaneously.

In one embodiment, the walker or rollator umbrella device comprises a body component. The body component is typically configured in a cylindrical shape but can be configured in any suitable shape as is known in the art. Generally, the body component is shaped to resemble a tube with one open end and one closed end. Typically, the body component comprises a bottom surface, a circular side wall, and opposing top and bottom walls which define an interior cavity accessed by an open top.

In one embodiment, the body component is sized and shaped to retain a plurality of different sized umbrellas. Typically, the interior cavity is an open cavity where the handle of an umbrella is inserted, to be easily opened and used. The exterior of the circular side wall features fasteners to be secured to a walker.

In one embodiment, the walker or rollator umbrella device comprises fasteners to attach the body component to the frame of a walker. Typically, the fasteners are clips although any suitable securing means as is known in the art may be used.

In one embodiment, the walker or rollator umbrella device in accordance with the present invention can be produced in various colors, designs, patterns, etc., and feature logos, emblems and or designs, such as a distributor requests and/or a user desires.

In one embodiment, the walker or rollator umbrella device is manufactured of a high-density polyethylene (HDPE), or any other suitable materials as is known in the art. Any number of different types of materials can be used to make the walker or rollator umbrella device including but not limited to plastics, nylon, textile materials, etc.

In use, the user attaches the body component to a walker via the fasteners. Further, the user inserts an umbrella into the body component. Next, the user opens the umbrella. Finally, the user utilizes the device to use a walker and umbrella simultaneously.

Thus, the walker or rollator umbrella device maintains independence for individuals who require a walker for mobility. The walker or rollator umbrella device may be attached to any type and style of walker and maintain support over the user.

It will also be appreciated that there are a number of additional add-on features that can be incorporated into the device and moreover, the walker or rollator umbrella device can take many different forms as is known in the art.

In yet another embodiment, the walker or rollator umbrella device comprises a plurality of indicia.

In yet another embodiment, a method of conveniently utilizing a walker and an umbrella simultaneously is disclosed. The method includes the steps of providing a walker or rollator umbrella device comprising a body component and fasteners. The method also comprises attaching the body component to a walker via the fasteners. Further, the method comprises inserting an umbrella into the body component. Next, the method comprises opening the umbrella. Finally, the method comprises utilizing the device to use a walker and umbrella simultaneously.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the walker or rollator umbrella device of the present invention attached to a walker in accordance with the disclosed architecture;

FIG. 2 illustrates a perspective view of one embodiment of the walker or rollator umbrella device of the present invention attached to a walked with an umbrella inserted in the device in accordance with the disclosed architecture;

FIG. 3 illustrates another perspective view of one embodiment of the walker or rollator umbrella device of the present invention attached to a walker with an umbrella inserted in the device in accordance with the disclosed architecture;

FIG. 4 illustrates a perspective view of a user utilizing one embodiment of the walker or rollator umbrella device of the present invention attached to a walker with an umbrella inserted in the device in accordance with the disclosed architecture;

FIG. 5 illustrates a perspective view of one embodiment of the walker or rollator umbrella device of the present invention attached to a different style of walker with an umbrella inserted in the device in accordance with the disclosed architecture; and

FIG. 6 illustrates a flowchart showing the method of conveniently utilizing a walker and umbrella simultaneously in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a walker or rollator umbrella device that provides users with a cylindrical holder for walkers designed to support an umbrella. There is also a long felt need in the art for a walker or rollator umbrella device that enables users to insert the umbrella handle into the holder and expand it, keeping it supported above the walker to keep the user dry and/or cool. Further, there is a long felt need in the art for a walker or rollator umbrella device that maintains independence for individuals who require a walker for mobility, enabling them to still go outdoors during sunny or rainy days. Finally, there is a long felt need in the art for a walker or rollator umbrella device that can be attached to any type and style of walker and maintain support over the user.

The present invention, in one exemplary embodiment, is a novel walker or rollator umbrella device. The device is a cylindrical holder for walkers designed to support an umbrella. The walker or rollator umbrella device enables users to insert the umbrella handle into the holder and expand it, keeping it supported above the walker. The walker or rollator umbrella device maintains independence for individuals who require a walker for mobility, enabling them to still go outdoors during sunny or rainy days. The umbrella walker device can be attached to any type and style of walker and maintain support over the user. Thus, once the device is attached to a walker, a user can place the handle of an umbrella into the device and stay dry and/or cool. Accordingly, the device preserves the independence of walker or rollator users. The present invention also includes a novel method of conveniently utilizing a walker and an umbrella simultaneously. The method includes the steps of providing a walker or rollator umbrella device comprising a body component and fasteners. The method also comprises attaching the body component to a walker via the fasteners. Further, the method comprises inserting an umbrella into the body component. Next, the method comprises opening the umbrella. Finally, the method comprises utilizing the device to use a walker and umbrella simultaneously.

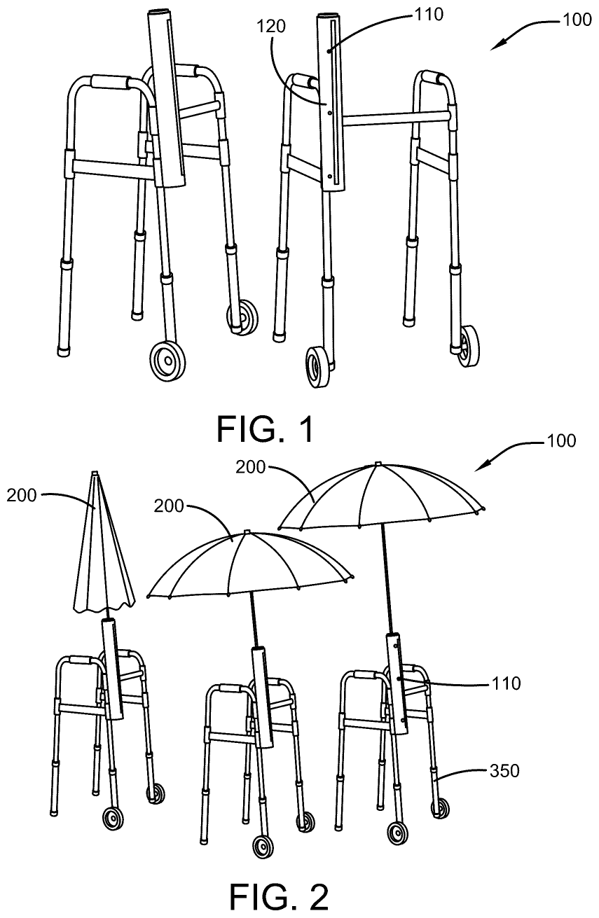

Referring initially to the drawings, FIG. 1 illustrates a perspective view of one embodiment of the walker or rollator umbrella device 100 of the present invention attached to a walker 350. In the present embodiment, the device 100 is an umbrella holder designed to be attached to a walker 350. The walker or rollator umbrella device 100 comprises a body component 110 and fasteners 120. Thus, once the device 100 is fastened to a walker 350, a user 300 can insert and open an umbrella 200 in the body component 110 and utilize the walker 350 and an umbrella 200 simultaneously.

As shown in FIG. 2, the walker or rollator umbrella device 100 comprises a body component 110. The body component 110 is typically configured in a cylindrical shape but can be configured in any suitable shape as is known in the art. Generally, the body component 110 is shaped to retain the handle of an umbrella 200. As is shown in the figures, the handle of the umbrella 200 is inserted into the body component 110 and the umbrella is then opened for use.

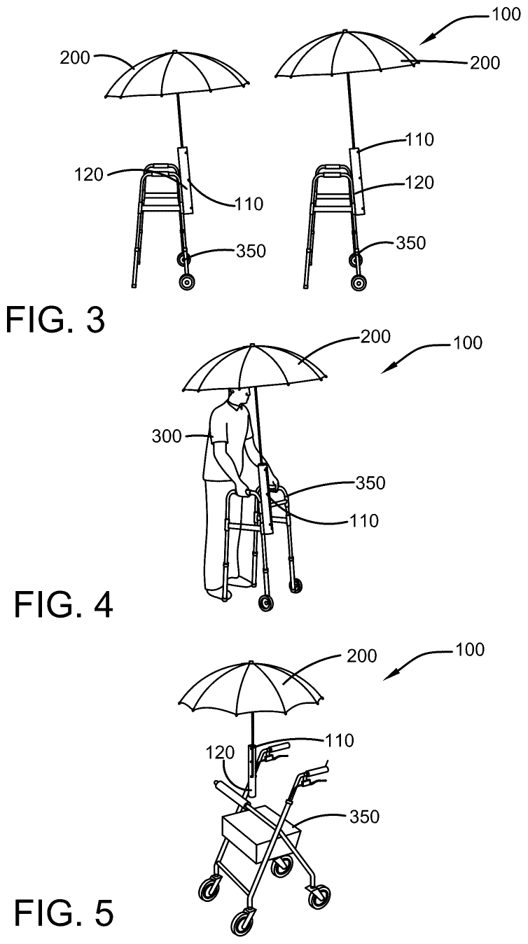

As shown in FIG. 3, the body component 110 is sized and shaped to retain a plurality of different sized umbrellas 200. Typically, the interior cavity is an open cavity where the handle of an umbrella 200 is inserted, to be easily opened and used. The exterior of the body component 110 features fasteners 120 to be secured to a walker 350.

In one embodiment, the walker or rollator umbrella device comprises fasteners to attach the body component to the frame of a walker. Typically, the fasteners are clips although any suitable securing means as is known in the art may be used.

As shown in FIG. 4, in use, the user 300 attaches the body component 110 to a walker 350 via the fasteners 120. Further, the user 300 inserts an umbrella 200 into the body component 110. Next, the user 300 opens the umbrella 200. Finally, the user 300 utilizes the device 100 to use a walker 350 and umbrella 200 simultaneously. Thus, the walker or rollator umbrella device 100 maintains independence for individuals who require a walker 350 for mobility. The walker or rollator umbrella device 100 may be attached to any type and style of walker 350 and maintain support over the user.

FIG. 5 illustrates a perspective view of one embodiment of the walker or rollator umbrella device 100 of the present invention attached to a different style of walker 350 with an umbrella inserted in the device 100. The fasteners 120 located on the body component 110 are designed to attach to any shape or style of walker 350.

It is to be appreciated that the walker or rollator umbrella device 100 in accordance with the present invention can be produced in various colors, designs, patterns, etc., and feature logos, emblems and or designs, such as a distributor requests and/or a user 300 desires.

In one embodiment, the walker or rollator umbrella device 100 is manufactured of a high-density polyethylene (HDPE), or any other suitable materials as is known in the art. Any number of different types of materials can be used to make the walker or rollator umbrella device 100 including but not limited to nylon, textile materials, heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the walker or rollator umbrella device 100 is also manufactured from a material that is water resistant or waterproof, or the body component 110 comprises a coating that is water resistant or waterproof.

In yet another embodiment, the walker or rollator umbrella device 100 comprises a plurality of indicia 400. The body component 110 of the device 100 may include advertising, a trademark, or other letters, designs, or characters, printed, painted, stamped, or integrated into the body component 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be umbrella, rain, or brand related.

It will also be appreciated that there are a number of additional add-on features that can be incorporated into the device 100 and moreover, the walker or rollator umbrella device 100 can take many different forms as is known in the art.

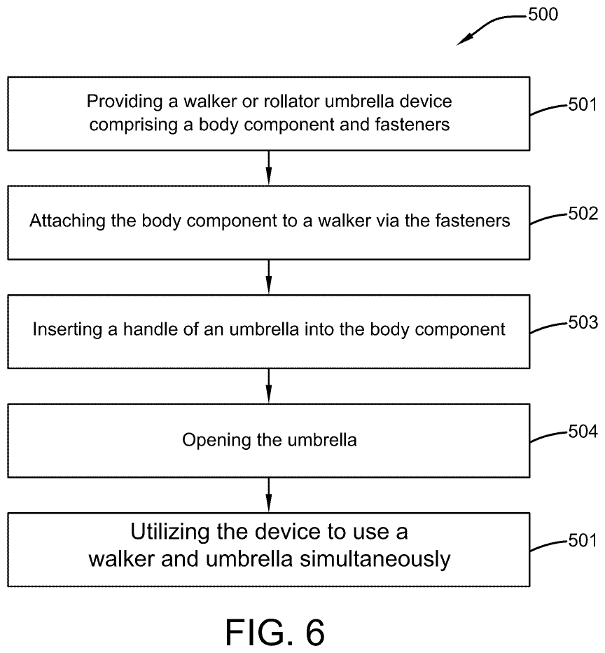

FIG. 6 illustrates a flowchart of the method 500 of conveniently utilizing a walker and an umbrella simultaneously. The method 500 includes the steps of at 501, providing a walker or rollator umbrella device comprising a body component and fasteners. The method also comprises at 502, attaching the body component to a walker via the fasteners. Further, the method comprises at 503, inserting a handle of an umbrella into the body component. Next, the method comprises at 504, opening the umbrella. Finally, the method comprises at 505, utilizing the device to use a walker and umbrella simultaneously.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “walker or rollator umbrella device”, “walker device”, “umbrella device”, and “device” are interchangeable and refer to the walker or rollator umbrella device 100 of the present invention.

Notwithstanding the forgoing, the walker or rollator umbrella device 100 of the present invention can be of any suitable size and configuration as is known in the art without affecting the overall concept of the invention, provided that it accomplishes the above stated objectives. One of ordinary skill in the art will appreciate that the walker or rollator umbrella device 100 as shown in FIGS. 1-5 is for illustrative purposes only, and that many other sizes and shapes of the walker or rollator umbrella device 100 are well within the scope of the present disclosure. Although the dimensions of the walker or rollator umbrella device 100 are important design parameters for user convenience, the walker or rollator umbrella device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A walker umbrella device comprising:
a walker;
a body component;
a plurality of fasteners; and
an umbrella;
wherein said body component having a cylindrical shape;
wherein said plurality of fasteners fasten said body component to said walker;
wherein said umbrella having a handle; and
further wherein said cylindrical shape receiving said handle of said umbrella for mounting said umbrella to said walker.

2. The walker umbrella device of claim 1, wherein said umbrella openable while mounted in said body component.

3. The walker umbrella device of claim 2, wherein said walker and said umbrella usable simultaneously.

4. The walker umbrella device of claim 3, wherein said body component having a material selected from the group consisting of a nylon, a heat-sealable polymer, a polypropylene and an acrylonitrile-butadiene-styrene (ABS).

5. The walker umbrella device of claim 3, wherein said body component having a material selected from the group consisting of an acrylic, a polycarbonate, a polyethylene, a polyethylene terephthalate, a polyvinyl chloride, and a polystyrene.

6. The walker umbrella device of claim 4, wherein said body component is waterproof.

7. The walker umbrella device of claim 5, wherein said body component is waterproof.

8. A walker umbrella device comprising:
a walker;
a body component;
a plurality of fasteners; and
an umbrella;
wherein said body component having an interior cavity;
wherein said plurality of fasteners fasten said body component to said walker;
wherein said umbrella having a handle;
wherein said interior cavity receiving said handle of said umbrella for mounting said umbrella to said walker;
wherein said umbrella openable while mounted in said body component; and
further wherein said walker and said umbrella usable simultaneously.

9. The walker umbrella device of claim 8, wherein said body component having a cylindrical shape.

10. The walker umbrella device of claim 9, wherein said body component having a material selected from the group consisting of a nylon, a heat-sealable polymer, a polypropylene and an acrylonitrile-butadiene-styrene (ABS).

11. The walker umbrella device of claim 9, wherein said body component having a material selected from the group consisting of an acrylic, a polycarbonate, a polyethylene, a polyethylene terephthalate, a polyvinyl chloride, and a polystyrene.

12. The walker umbrella device of claim 10, wherein said body component is waterproof.

13. The walker umbrella device of claim 11, wherein said body component is waterproof.

14. A method of using a walker and an umbrella, the method comprising the steps of:
providing a walker, a body component, a plurality of fasteners, and an umbrella, wherein said body component having an interior cavity, wherein said umbrella having a handle;
fastening said body component to said walker with said plurality of fasteners;
inserting said handle of said umbrella into said interior cavity for mounting said umbrella to said walker; and
opening said umbrella while mounted in said body component.

15. The method of using a walker and an umbrella of claim 14, wherein said body component having a cylindrical shape.

16. The method of using a walker and an umbrella of claim 15, wherein said body component having a material selected from the group consisting of a nylon, a heat-sealable polymer, a polypropylene and an acrylonitrile-butadiene-styrene (ABS).

17. The method of using a walker and an umbrella of claim 15, wherein said body component having a material selected from the group consisting of an acrylic, a polycarbonate, a polyethylene, a polyethylene terephthalate, a polyvinyl chloride, and a polystyrene.

18. The method of using a walker and an umbrella of claim 16, wherein said body component is waterproof.

19. The method of using a walker and an umbrella of claim 17, wherein said body component is waterproof.

20. The method of using a walker and an umbrella of claim 14, wherein said walker and said umbrella usable simultaneously.
